(19) United States
(12) Patent Application Publication
(10) Pub. No.: US 2018/0053233 A1
(43) Pub. Date: Feb. 22, 2018

(54) EXPANDABLE SERVICE ARCHITECTURE WITH CONFIGURABLE ORCHESTRATOR

(71) Applicant: eBay Inc., San Jose, CA (US)

(72) Inventor: Amit Srivastava, San Jose, CA (US)

(21) Appl. No.: 15/238,612

(22) Filed: Aug. 16, 2016

(51) Int. Cl. G06Q 30/06; G06F 17/30; G06N 99/00

(52) U.S. Cl. CPC G06Q 30/0625; G06F 17/30864; G06N 99/005; G06F 17/30477

(57) ABSTRACT

Methods, systems, and computer programs are presented for adding new features to a network service. A method includes an operation for receiving, by an orchestrator, a sequence specification for a user activity that identifies a type of interaction between a user and the network service, which includes the orchestrator and service servers. The sequence specification includes a sequence of interactions between the orchestrator and a set of service servers to implement the user activity. Further, the method includes operations for configuring the orchestrator to execute the sequence specification when the user activity is detected, for processing user input to detect an intent of the user, and for determining that the intent corresponds to the user activity. The orchestrator executes the sequence specification by invoking the set of service servers, and by causing presentation to the user of a result responsive to the intent of the user.

### TECHNICAL FIELD

The subject matter disclosed herein generally relates to the technical field of special-purpose machines that facilitate adding new features to a network service, including software-configured computerized variants of such special-purpose machines and improvements to such variants, and to the technologies by which such special-purpose machines become improved compared to other special-purpose machines that facilitate adding the new features.

### BACKGROUND

Conventional shopping searches are time consuming because current search tools provide rigid and limited search user interfaces; too much selection and too much time can be wasted browsing pages and pages of results. Trapped by the technical limitations of conventional tools, it may be difficult for a user to simply communicate what the user wants, e.g., the user's intent. For example a user cannot share photos of products to help with a search.

As the number of online for-sale items balloons to billions of items, comparison searching has become more critical than ever. Current solutions are not designed for this scale, and irrelevant results are often shown, while the best results may be buried among the noise created by thousands of search results.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 is a diagram illustrating the operation of the intelligent assistant, according to some example embodiments.

FIG. 3 illustrates the features of the artificial intelligence (AI) framework, according to some example embodiments.

FIG. 4 is a diagram illustrating a service architecture according to some example embodiments.

FIG. 5 is a block diagram for implement the AI framework, according to some example embodiments.

FIG. 6 is a graphical representation of a service sequence for a chat search with input text, according to some example embodiments.

FIG. 7 is a graphical representation of a service sequence for a search with image input, according to some example embodiments.

FIG. 8 is a graphical representation of a service sequence for a chat turn with speech input, according to some example embodiments.

FIG. 9 is a graphical representation of a service sequence for a chat with a structured answer, according to some example embodiments.

FIG. 10 is a graphical representation of a service sequence for a recommending deals, according to some example embodiments.

FIG. 11 is a graphical representation of a service sequence to execute the last query, according to some example embodiments.

FIG. 12 is a graphical representation of a service sequence for getting status for the user, according to some example embodiments.

FIG. 13 is a flowchart of a method for configuring the orchestrator to implement a new activity, according to some example embodiments.

FIG. 14 is a block diagram illustrating an example embodiment of an architecture of the orchestrator.

FIG. 15 is a flowchart of a method, according to some example embodiments, for adding new features to a network service.

FIG. 16 is a block diagram illustrating an example of a software architecture that may be installed on a machine, according to some example embodiments.

### DETAILED DESCRIPTION

Example methods, systems, and computer programs are directed to adding new features to a network service. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Generally, enabling an intelligent personal assistant system includes a scalable artificial intelligence (AI) framework, also referred to as AI architecture, that permeates the fabric of existing messaging platforms to provide an intelligent online personal assistant, referred to herein as “bot”. The AI framework provides intelligent, personalized answers in predictive turns of communication between a human user and the intelligent online personal assistant.

An orchestrator component effects specific integration and interaction of components within the AI architecture. The orchestrator acts as the conductor that integrates the capabilities provided by a plurality of services. In one aspect, the orchestrator component decides which part of the AI framework to activate (e.g., for image input, activate computer vision service, and for input speech, activate speech recognition).

One general aspect includes a method including an operation for receiving, by an orchestrator server, a sequence specification for a user activity that identifies a type of interaction between a user and a network service. The network service includes the orchestrator server and one or more service servers, and the sequence specification includes a sequence of interactions between the orchestrator server and a set of one or more service servers from the one or more service servers to implement the user activity. The method also includes configuring the orchestrator server to execute the sequence specification when the user activity is detected, processing user input to detect an intent of the user associated with the user input, and determining that the intent of the user corresponds to the user activity. The orchestrator server executes the sequence specification by invoking the set of one or more service servers of the sequence specification, the executing of the sequence specification causing presentation to the user of a result responsive to the intent of the user detected in the user input.

One general aspect includes an orchestrator server including a memory having instructions and one or more computer processors. The instructions, when executed by the one or more computer processors, cause the one or more computer processors to perform operations, including receiving a sequence specification for a user activity that identifies a type of interaction between a user and a network service. The network service includes the orchestrator server and one or more service servers, and the sequence specification includes a sequence of interactions between the orchestrator server and a set of one or more service servers from the one or more service servers to implement the user activity. The operations also include configuring the orchestrator server to execute the sequence specification when the user activity is detected, processing user input to detect an intent of the user associated with the user input, and determining that the intent of the user corresponds to the user activity. The orchestrator server executes the sequence specification by invoking the set of one or more service servers of the sequence specification, the executing of the sequence specification causing presentation to the user of a result responsive to the intent of the user detected in the user input.

One general aspect includes a non-transitory machine-readable storage medium including instructions that, when executed by a machine, cause the machine to perform operations including receiving, by an orchestrator server, a sequence specification for a user activity that identifies a type of interaction between a user and a network service. The network service includes the orchestrator server and one or more service servers, and the sequence specification includes a sequence of interactions between the orchestrator server and a set of one or more service servers from the one or more service servers to implement the user activity. The operations also include configuring the orchestrator server to execute the sequence specification when the user activity is detected, processing user input to detect an intent of the user associated with the user input, and determining that the intent of the user corresponds to the user activity. The orchestrator server executes the sequence specification by invoking the set of one or more service servers of the sequence specification, the executing of the sequence specification causing presentation to the user of a result responsive to the intent of the user detected in the user input.

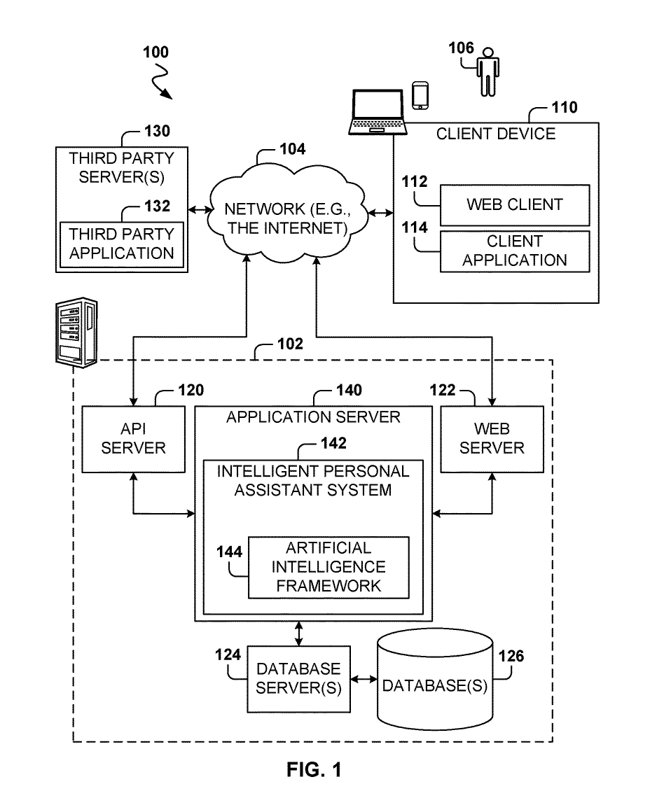

FIG. 1 is a block diagram illustrating a networked system, according to some example embodiments. With reference to FIG. 1, an example embodiment of a high-level client-server-based network architecture 100 is shown. A networked system 102, in the example forms of a network-based marketplace or payment system, provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Wash. State), an application 114, and a programmatic client 116 executing on client device 110.

The client device 110 may comprise, but are not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may utilize to access the networked system 102. In some embodiments, the client device 110 may comprise a display module (not shown) to display information (e.g., in the form of user interfaces). In further embodiments, the client device 110 may comprise one or more of a touch screens, accelerometers, gyroscopes, cameras, microphones, global positioning system (GPS) devices, and so forth. The client device 110 may be a device of a user that is used to perform a transaction involving digital items within the networked system 102. In one embodiment, the networked system 102 is a network-based marketplace that responds to requests for product listings, publishes publications comprising item listings of products available on the network-based marketplace, and manages payments for these marketplace transactions. One or more users 106 may be a person, a machine, or other means of interacting with client device 110. In embodiments, the user 106 is not part of the network architecture 100, but may interact with the network architecture 100 via client device 110 or another means. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the client device 110 may include one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given one of the client device 110, then this application is configured to locally provide the user interface and at least some of the functionalities with the application configured to communicate with the networked system 102, on an as needed basis, for data or processing capabilities not locally available (e.g., access to a database of items available for sale, to authenticate a user, to verify a method of payment, etc.). Conversely if the e-commerce site application is not included in the client device 110, the client device 110 may use its web browser to access the e-commerce site (or a variant thereof) hosted on the networked system 102.

One or more users 106 may be a person, a machine, or other means of interacting with the client device 110. In example embodiments, the user 106 is not part of the network architecture 100, but may interact with the network architecture 100 via the client device 110 or other means. For instance, the user provides input (e.g., touch screen input or alphanumeric input) to the client device 110 and the input is communicated to the networked system 102 via the network 104. In this instance, the networked system 102, in response to receiving the input from the user, communicates information to the client device 110 via the network 104 to be presented to the user. In this way, the user can interact with the networked system 102 using the client device 110.

An application program interface (API) server 216 and a web server 218 are coupled to, and provide programmatic and web interfaces respectively to, one or more application servers 140. The application server 140 host the intelligent personal assistant system 142, which includes the artificial intelligence framework 144, each of which may comprise one or more modules or applications and each of which may be embodied as hardware, software, firmware, or any combination thereof.

The application server 140 is, in turn, shown to be coupled to one or more database servers 226 that facilitate access to one or more information storage repositories or databases 226. In an example embodiment, the databases 226 are storage devices that store information to be posted (e.g., publications or listings) to the publication system 242. The databases 226 may also store digital item information in accordance with example embodiments.

Additionally, a third-party application 132, executing on third-party servers 130, is shown as having programmatic access to the networked system 102 via the programmatic interface provided by the API server 216. For example, the third-party application 132, utilizing information retrieved from the networked system 102, supports one or more features or functions on a website hosted by the third party. The third-party website, for example, provides one or more promotional, marketplace, or payment functions that are supported by the relevant applications of the networked system 102.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The various publication system 142, payment system 144, and personalization system 150 could also be implemented as standalone software programs, which do not necessarily have networking capabilities.

The web client 212 may access the intelligent personal assistant system 142 via the web interface supported by the web server 218. Similarly, the programmatic client 116 accesses the various services and functions provided by the intelligent personal assistant system 142 via the programmatic interface provided by the API server 216.

Additionally, a third-party application(s) 208, executing on a third-party server(s) 130, is shown as having programmatic access to the networked system 102 via the programmatic interface provided by the API server 114. For example, the third-party application 208, utilizing information retrieved from the networked system 102, may support one or more features or functions on a website hosted by the third party. The third-party website may, for example, provide one or more promotional, marketplace, or payment functions that are supported by the relevant applications of the networked system 102.

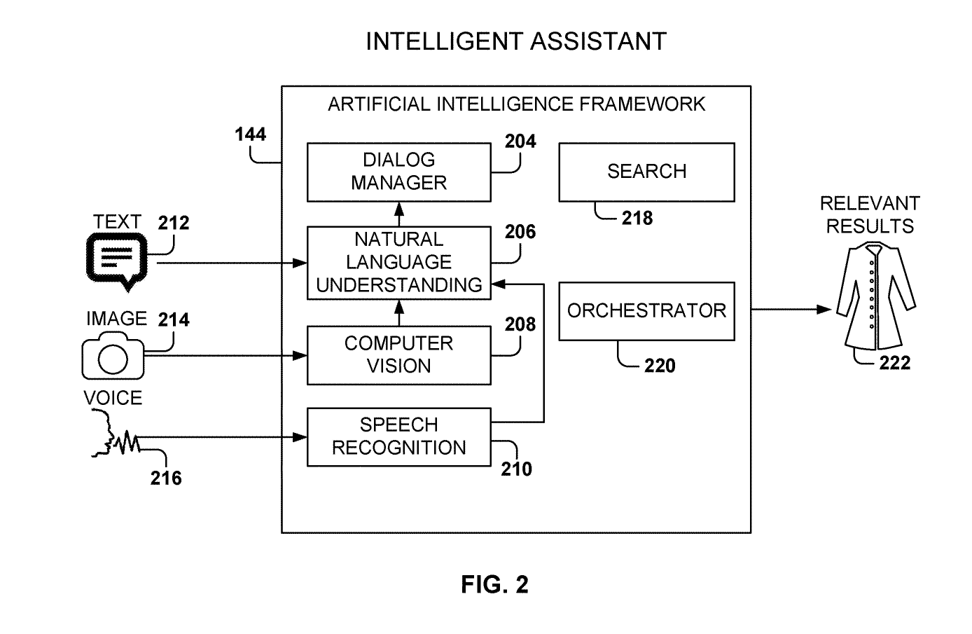

FIG. 2 is a diagram illustrating the operation of the intelligent assistant, according to some example embodiments. Today's online shopping is impersonal, unidirectional, and not conversational. Buyers cannot speak in plain language to convey their wishes, making it difficult to convey intent. Shopping on a commerce site is usually more difficult than speaking with a salesperson or a friend about a product, so oftentimes buyers have trouble finding the products they want.

Embodiments present a personal shopping assistant, also referred to as an intelligent assistant, that supports a two-way communication with the shopper to build context and understand the intent of the shopper, enabling delivery of better, personalized shopping results. The intelligent assistant has a natural, human-like dialog, that helps a buyer with ease, increasing the likelihood that the buyer will reuse the intelligent assistant for future purchases.

The artificial intelligence framework 144 understands the user and the available inventory to respond to natural-language queries and has the ability to deliver a incremental improvements in anticipating and understanding the customer and their needs.

The artificial intelligence framework (AIF) 144 includes a dialogue manager 504, natural language understanding (NLU) 206, computer vision 208, speech recognition 210, search 218, and orchestrator 220. The AIF 144 is able to receive different kinds of inputs, such as text input 212, image input 214 and voice input 216, to generate relevant results 222. As used herein, the AIF 144 includes a plurality of services (e.g., NLU 206, computer vision 208) that are implemented by corresponding servers, and the terms service or server may be utilized to identify the service and the corresponding service.

The natural language understanding (NLU) 206 unit processes natural language text input 212, both formal and informal language, detects the intent of the text, and extracts useful information, such as objects of interest and their attributes. The natural language user input can thus be transformed into a structured query using rich information from additional knowledge to enrich the query even further. This information is then passed on to the dialog manager 504 through the orchestrator 220 for further actions with the user or with the other components in the overall system. The structured and enriched query is also consumed by search 218 for improved matching. The text input may be a query for a product, a refinement to a previous query, or other information to an object of relevance (e.g., shoe size).

The computer vision 208 takes image as an input and performs image recognition to identify the characteristics of the image (e.g., item the user wants to ship), which are then transferred to the NLU 206 for processing. The speech recognition 210 takes speech 216 as an input and performs language recognition to convert speech to text, which is then transferred to the NLU for processing.

The NLU 206 determines the object, the aspects associated with the object, how to create the search interface input, and how to generate the response. For example, the AI 144 may ask questions to the user to clarify what the user is looking for. This means that the AIF 144 not only generates results, but also may create a series of interactive operations to get to the optimal, or close to optimal, results 222.

For example, in response to the query, “Can you find me a pair of red nike shoes?” the AIF 144 may generate the following parameters: <intent:shopping, statement-type:question, dominant-object:shoes, target:self, color:red, brand:nike>. To the query, “I am looking for a pair of sunglasses for my wife,” the NLU may generate <intent: shopping, statement-type: statement, dominant-object: sunglasses, target:wife, target-gender:female>.

The dialogue manager 504 is the module that analyzes the query of a user to extract meaning, and determines if there is a question that needs to be asked in order to refine the query, before sending the query to search 218. The dialogue manager 504 uses the current communication in context of the previous communication between the user and the artificial intelligence framework 144. The questions are automatically generated dependent on the combination of the accumulated knowledge (e.g., provided by a knowledge graph) and what search can extract out of the inventory. The dialogue manager's job is to create a response for the user. For example, if the user says, “hello,” the dialogue manager 504 generates a response, “Hi, my name is bot.”

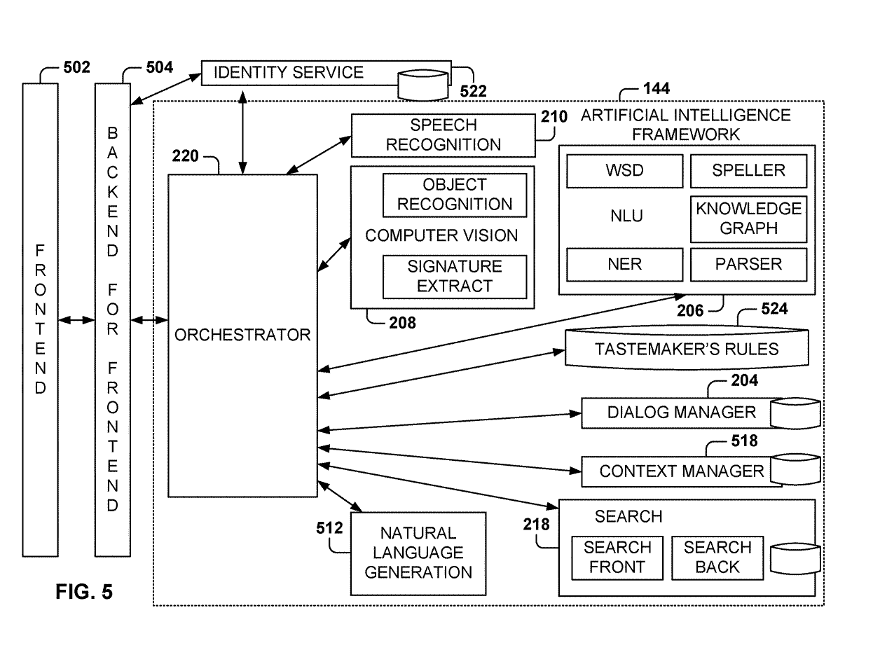

The orchestrator 220 coordinates the interactions between the other services within the artificial intelligence framework 144. More details are provided below about the interactions of the orchestrator 220 with other services with reference to FIG. 5.

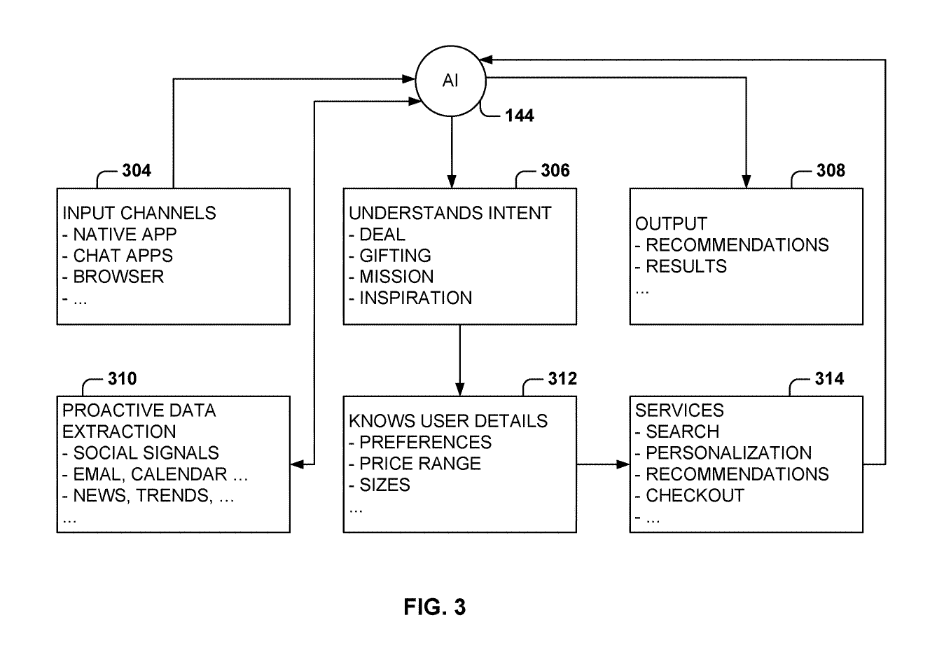

FIG. 3 illustrates the features of the artificial intelligence (AI) framework 144, according to some example embodiments. The AIF 144 is able to interact with several input channels 304, such as native commerce applications, chat applications, social networks, browsers, etc. In addition, the AIF 144 understands the intent 306 expressed by the user. For example, the intent may include a user looking for a good deal, or a user looking for a gift, or a user on a mission to buy a specific product, a user looking for suggestions, etc.

Further, the AIF 144 performs proactive data extraction 310 from multiple sources, such as social networks, email, calendar, news, market trends, etc. The AIF 144 knows about user details 312, such as user preferences, desired price ranges, sizes, affinities, etc. The AIF 144 facilitates a plurality of services within the service network, such as product search, personalization, recommendations, checkout features, etc. The output 308 may include recommendations, results, etc.

The AIF 144 is an intelligent and friendly system that understands the user's intent (e.g., targeted search, compare, shop, browse), mandatory parameters (e.g., product, product category, item), optional parameters (e.g., aspects of the item, color, size, occasion), as well as implicit information (e.g., geo location, personal preferences, age, gender). The AIF 144 responds with a well designed response in plain language.

For example, the AIF 144 may process inputs queries, such as: “Hey! Can you help me find a pair of light pink shoes for my girlfriend please? With heels. Up to $200. Thanks;” “I recently searched for a men's leather jacket with a classic James Dean look. Think almost Harrison Ford's in the new Star Wars movie. However, I'm looking for quality in a price range of $200-300. Might not be possible, but I wanted to see!”; or “I'm looking for a black Northface Thermoball jacket.”

Instead of a hardcoded system, the AIF 144 provides a configurable, flexible interface with machine learning capabilities for ongoing improvement. The AIF 144 supports a commerce system that provides value (connecting the user to the things that the user wants), intelligence (knowing and learning from the user and the user behavior to recommend the right items), convenience (offering a plurality of user interfaces), easy of-use, and efficiency (saves the user time and money).

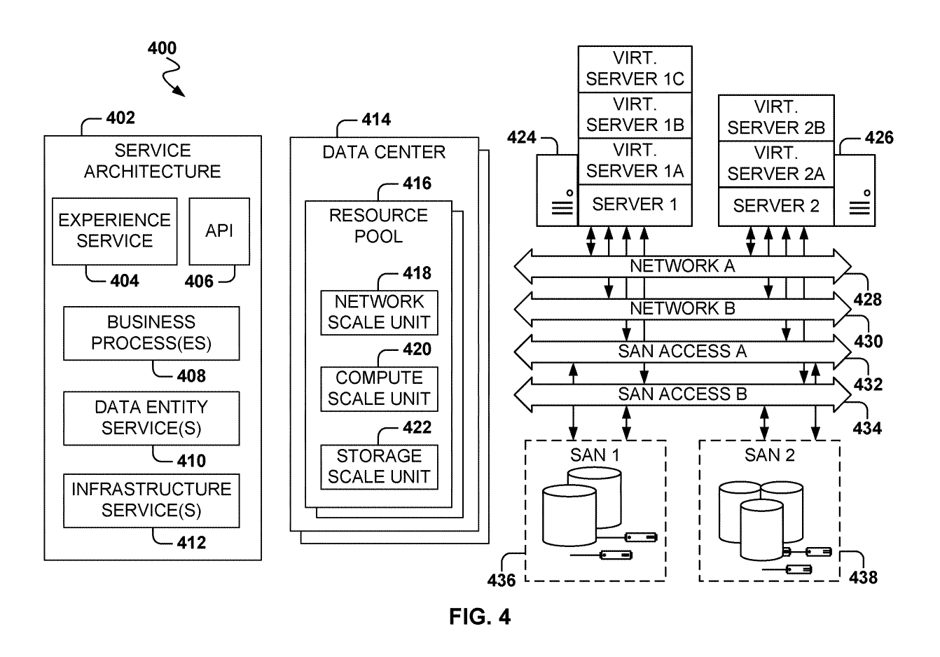

FIG. 4 is a diagram illustrating a service architecture 400 according to some embodiments. The service architecture 400 presents various views of the service architecture in order to describe how the service architecture may be deployed on various data centers or cloud services. The architecture 400 represents a suitable environment for implementation of the embodiments described herein.

The service architecture 402 represents how a cloud architecture typically appears to a user, developer and so forth. The architecture is generally an abstracted representation of the actual underlying architecture implementation, represented in the other views of FIG. 1. For example, the service architecture 402 comprises a plurality of layers, that represent different functionality and/or services associated with the service architecture 402.

The experience service layer 404 represents a logical grouping of services and features from the end customer's point of view, built across different client platforms, such as applications running on a platform (mobile phone, desktop, etc.), web based presentation (mobile web, desktop web browser, etc.), and so forth. It includes rendering user interfaces and providing information to the client platform so that appropriate user interfaces can be rendered, capturing client input, and so forth. In the context of a marketplace, examples of services that would reside in this layer are home page (e.g., home view), view item listing, search/view search results, shopping cart, buying user interface and related services, selling user interface and related services, after sale experiences (posting a transaction, feedback, etc.), and so forth. In the context of other systems, the experience service layer 404 would incorporate those end user services and experiences that are embodied by the system.

The API layer 406 contains APIs which allow interaction with business process and core layers. This allows third party development against the service architecture 402 and allows third parties to develop additional services on top of the service architecture 402.

The business process service layer 408 is where the business logic resides for the services provided. In the context of a marketplace this is where services such as user registration, user sign in, listing creation and publication, add to shopping cart, place an offer, checkout, send invoice, print labels, ship item, return item, and so forth would be implemented. The business process service layer 408 also orchestrates between various business logic and data entities and thus represents a composition of shared services. The business processes in this layer can also support multi-tenancy in order to increase compatibility with some cloud service architectures.

The data entity service layer 410 enforces isolation around direct data access and contains the services upon which higher level layers depend. Thus, in the marketplace context this layer can comprise underlying services like order management, financial institution management, user account services, and so forth. The services in this layer typically support multi-tenancy.

The infrastructure service layer 412 comprises those services that are not specific to the type of service architecture being implemented. Thus, in the context of a marketplace, the services in this layer are services that are not specific or unique to a marketplace. Thus, functions like cryptographic functions, key management, CAPTCHA, authentication and authorization, configuration management, logging, tracking, documentation and management, and so forth reside in this layer.

Embodiments of the present disclosure will typically be implemented in one or more of these layers. In particular, the AIF 144, as well as the orchestrator 220 and the other services of the AIF 144.

The data center 414 is a representation of the various resource pools 416 along with their constituent scale units. This data center representation illustrates the scaling and elasticity that comes with implementing the service architecture 402 in a cloud computing model. The resource pool 416 is comprised of server (or compute) scale units 420, network scale units 418 and storage scale units 422. A scale unit is a server, network and/or storage unit that is the smallest unit capable of deployment within the data center. The scale units allow for more capacity to be deployed or removed as the need increases or decreases.

The network scale unit 418 contains one or more networks (such as network interface units, etc.) that can be deployed. The networks can include, for example virtual LANs. The compute scale unit 420 typically comprise a unit (server, etc.) that contains a plurality processing units, such as processors. The storage scale unit 422 contains one or more storage devices such as disks, storage attached networks (SAN), network attached storage (NAS) devices, and so forth. These are collectively illustrated as SANs in the description below. Each SAN may comprise one or more volumes, disks, and so forth.

The remaining view of FIG. 1 illustrates another example of a service architecture 400. This view is more hardware focused and illustrates the resources underlying the more logical architecture in the other views of FIG. 1. A cloud computing architecture typically has a plurality of servers or other systems 424, 426. These servers comprise a plurality of real and/or virtual servers. Thus the server 424 comprises server 1 along with virtual servers 1A, 1B, 1C and so forth.

The servers are connected to and/or interconnected by one or more networks such as network A 428 and/or network B 430. The servers are also connected to a plurality of storage devices, such as SAN 1 (436), SAN 2 (438) and so forth. SANs are typically connected to the servers through a network such as SAN access A 432 and/or SAN access B 434.

The compute scale units 420 are typically some aspect of servers 424 and/or 426, like processors and other hardware associated therewith. The network scale units 418 typically include, or at least utilize the illustrated networks A (428) and B (432). The storage scale units typically include some aspect of SAN 1 (436) and/or SAN 2 (438). Thus, the logical service architecture 402 can be mapped to the physical architecture.

Services and other implementation of the embodiments described herein will run on the servers or virtual servers and utilize the various hardware resources to implement the disclosed embodiments.

FIG. 5 is a block diagram for implement the AIF 144, according to some example embodiments. Specifically, the intelligent personal assistant system 106 of FIG. 2 is shown to include a front end component 502 (FE) by which the intelligent personal assistant system 106 communicates (e.g., over the network 104) with other systems within the network architecture 100. The front end component 502 can communicate with the fabric of existing messaging systems. As used herein, the term messaging fabric refers to a collection of APIs and services that can power third party platforms such as Facebook messenger, Microsoft Cortana, and others “bots.” In one example, a messaging fabric can support an online commerce ecosystem that allows users to interact with commercial intent. Output of the front end component 502 can be rendered in a display of a client device, such as the client device 110 in FIG. 1 as part of an interface with the intelligent personal assistant.

The front end component 502 of the intelligent personal assistant system 106 is coupled to a back end component 504 for the front end (BFF) that operates to link the front end component 502 with the AIF 144. The artificial intelligence framework 144 includes several components discussed below.

In one example embodiment, an orchestrator 220 orchestrates communication of components inside and outside the artificial intelligence framework 144. Input modalities for the AI orchestrator 206 are derived from a computer vision component 208, a speech recognition component 210, and a text normalization component which may form part of the speech recognition component 210. The computer vision component 208 may identify objects and attributes from visual input (e.g., photo). The speech recognition component 210 converts audio signals (e.g., spoken utterances) into text. The text normalization component operates to make input normalization, such as language normalization by rendering emoticons into text, for example. Other normalization is possible such as orthographic normalization, foreign language normalization, conversational text normalization, and so forth.

The artificial intelligence framework 144 further includes a natural language understanding (NLU) component 206 that operates to parse and extract user intent and intent parameters (for example mandatory or optional parameters). The NLU component 206 is shown to include sub-components such as a spelling corrector (speller), a parser, a named entity recognition (NER) sub-component, a knowledge graph, and a word sense detector (WSD).

The artificial intelligence framework 144 further includes a dialog manager 204 that operates to understand a “completeness of specificity” (for example of an input, such as a search query or utterance) and decide on a next action type and a parameter (e.g., “search” or “request further information from user”). In one example, the dialog manager 204 operates in association with a context manager 518 and a natural language generation (NLG) component 512. The context manager 518 manages the context and communication of a user with respect to online personal assistant (or “bot”) and the assistant's associated artificial intelligence. The context manager 518 comprises two parts: long term history and short term memory. Data entries into one or both of these parts can include the relevant intent and all parameters and all related results of a given input, bot interaction, or turn of communication, for example. The NLG component 512 operates to compose a natural language utterance out of a AI message to present to a user interacting with the intelligent bot.

A search component 218 is also included within the artificial intelligence framework 144. As shown, the search component 218 has a front-end and a back-end unit. The back-end unit operates to manage item and product inventory and provide functions of searching against the inventory, optimizing towards a specific tuple of intent and intent parameters. An identity service 522 component, that may or may not form part of artificial intelligence framework 144, operates to manage user profiles, for example explicit information in the form of user attributes (e.g., “name,” “age,” “gender,” “geolocation”), but also implicit information in forms such as “information distillates” such as “user interest,” or “”similar persona,” and so forth. The identity service 522 includes a set of policies, APIs, and services that elegantly centralizes all user information, enabling the AIF 144 to have insights into the users' wishes. Further, the identity service 522 protects the commerce system and its users from fraud or malicious use of private information.

The functionalities of the artificial intelligence framework 144 can be set into multiple parts, for example decision-making and context parts. In one example, the decision-making part includes operations by the orchestrator 220, the NLU component 206 and its subcomponents, the dialog manager 204, the NLG component 512, the computer vision component 208 and speech recognition component 210. The context part of the AI functionality relates to the parameters (implicit and explicit) around a user and the communicated intent (for example, towards a given inventory, or otherwise). In order to measure and improve AI quality over time, in some example embodiments, the artificial intelligence framework 144 is trained using sample queries (e.g., a development set) and tested on a different set of queries (e.g., an [0001] evaluation set), both sets to be developed by human curation or from use data. Also, the artificial intelligence framework 144 is to be trained on transaction and interaction flows defined by experienced curation specialists, or human override 524. The flows and the logic encoded within the various components of the artificial intelligence framework 144 define what follow-up utterance or presentation (e.g., question, result set) is made by the intelligent assistant based on an identified user intent.

The intelligent personal assistant system 106 seeks to understand a user's intent (e.g., targeted search, compare, shop, browse, and so forth), mandatory parameters (e.g., product, product category, item, and so forth), and optional parameters (e.g., explicit information, e.g., aspects of item/product, occasion, and so forth), as well as implicit information (e.g., geolocation, personal preferences, age and gender, and so forth) and respond to the user with a content-rich and intelligent response. Explicit input modalities can include text, speech, and visual input and can be enriched with implicit knowledge of user (e.g., geolocation, gender, birthplace, previous browse history, and so forth). Output modalities can include text (such as speech, or natural language sentences, or product-relevant information, and images on the screen of a smart device e.g., client device 110. Input modalities thus refer to the different ways users can communicate with the bot. Input modalities can also include keyboard or mouse navigation, touch-sensitive gestures, and so forth.

In relation to a modality for the computer vision component 208, a photograph can often represent what a user is looking for better than text. Also, the computer vision component 208 may be used to form shipping parameters based on the image of the item to be shipped. The user may not know what an item is called, or it may be hard or even impossible to use text for fine detailed information that an expert may know, for example a complicated pattern in apparel or a certain style in furniture. Moreover, it is inconvenient to type complex text queries on mobile phones and long text queries typically have poor recall. Key functionalities of the computer vision component 208 include object localization, object recognition, optical character recognition (OCR) and matching against inventory based on visual cues from an image or video. A bot enabled with computer vision is advantageous when running on a mobile device which has a built-in camera. Powerful deep neural networks can be used to enable computer vision applications.

With reference to the speech recognition component 210, a feature extraction component operates to convert raw audio waveform to some-dimensional vector of numbers that represents the sound. This component uses deep learning to project the raw signal into a high-dimensional semantic space. An acoustic model component operates to host a statistical model of speech units, such as phonemes and allophones. These can include Gaussian Mixture Models (GMM) although the use of Deep Neural Networks is possible. A language model component uses statistical models of grammar to define how words are put together in a sentence. Such models can include n-gram-based models or Deep Neural Networks built on top of word embeddings. A speech-to-text (STT) decoder component converts a speech utterance into a sequence of words typically leveraging features derived from a raw signal using the feature extraction component, the acoustic model component, and the language model component in a Hidden Markov Model (HMM) framework to derive word sequences from feature sequences. In one example, a speech-to-text service in the cloud has these components deployed in a cloud framework with an API that allows audio samples to be posted for speech utterances and to retrieve the corresponding word sequence. Control parameters are available to customize or influence the speech-to-text process.

Machine-learning algorithms may be used for matching, relevance, and final re-ranking by the AIF 144 services. Machine learning is a field of study that gives computers the ability to learn without being explicitly programmed. Machine learning explores the study and construction of algorithms that can learn from and make predictions on data. Such machine-learning algorithms operate by building a model from example inputs in order to make data-driven predictions or decisions expressed as outputs. Machine-learning algorithms may also be used to teach how to implement a process.

Deep learning models, deep neural network (DNN), recurrent neural network (RNN), convolutional neural network (CNN), and long short-term CNN, as well as other ML models and IR models may be used. For example, search 218 may use n-gram, entity, and semantic vector-based query to product matching. Deep-learned semantic vectors give the ability to match products to non-text inputs directly. Multi-leveled relevance filtration may use BM25, predicted query leaf category+product leaf category, semantic vector similarity between query and product, and other models, to pick the top candidate products for the final re-ranking algorithm.

Predicted click-through-rate and conversion rate, as well as GMV, constitutes the final re-ranking formula to tweak functionality towards specific business goals, more shopping engagement, more products purchased, or more GMV. Both the click prediction and conversion prediction models take in query, user, seller and product as input signals. User profiles are enriched by learning from onboarding, sideboarding, and user behaviors to enhance the precision of the models used by each of the matching, relevance, and ranking stages for individual users. To increase the velocity of model improvement, offline evaluation pipeline is used before online A/B testing.

In one example of an artificial intelligence framework 144, two additional parts for the speech recognition component 210 are provided, a speaker adaptation component and an LM adaptation component. The speaker adaptation component allows clients of an STT system (e.g., speech recognition component 210) to customize the feature extraction component and the acoustic model component for each speaker. This can be important because most speech-to-text systems are trained on data from a representative set of speakers from a target region and typically the accuracy of the system depends heavily on how well the target speaker matches the speakers in the training pool. The speaker adaptation component allows the speech recognition component 210 (and consequently the artificial intelligence framework 144) to be robust to speaker variations by continuously learning the idiosyncrasies of a user's intonation, pronunciation, accent, and other speech factors and apply these to the speech-dependent components, e.g., the feature extraction component, and the acoustic model component. While this approach utilizes a non-significant-sized voice profile to be created and persisted for each speaker, the potential benefits of accuracy generally far outweigh the storage drawbacks.

The language model (LM) adaptation component operates to customize the language model component and the speech-to-text vocabulary with new words and representative sentences from a target domain, for example, inventory categories or user personas. This capability allows the artificial intelligence framework 144 to be scalable as new categories and personas are supported.

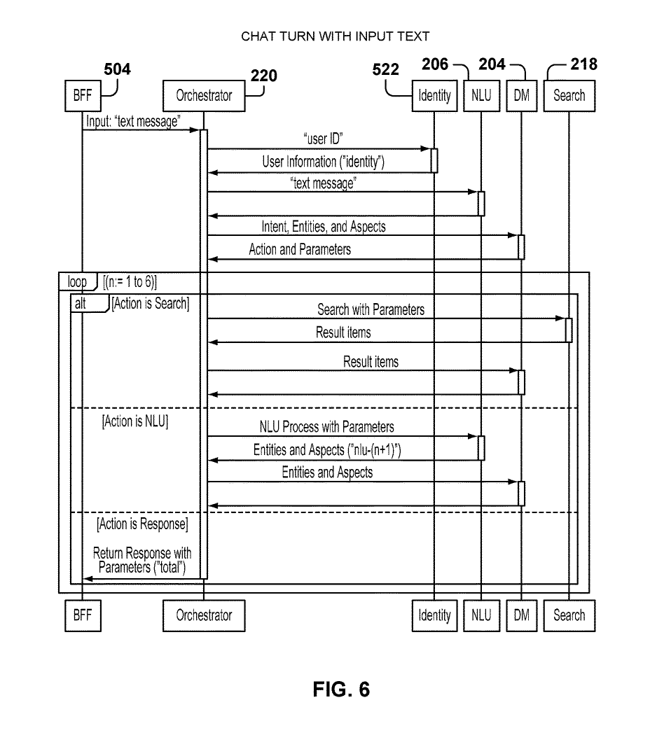

The AIF's goal is to provide a scalable and expandable framework for AI, one in which new activities, also referred to herein as missions, can be accomplished dynamically using the services that perform specific natural-language processing functions. Adding a new service does not require to redesign the complete system. Instead, the services are prepared (e.g., using machine-learning algorithms) if necessary, and the orchestrator is configured with a new sequence related to the new activity. More details regarding the configuration of sequences are provided below with reference to FIGS. 6-13.

Embodiments presented herein provide for dynamic configuration of the orchestrator 220 to learn new intents and how to respond to the new intents. In some example embodiments, the orchestrator 220 “learns” new skills by receiving a configuration for a new sequence associated with the new activity. The sequence specification includes a sequence of interactions between the orchestrator 220 and a set of one or more service servers from the AIF 144. In some example embodiments, each interaction of the sequence includes (at least): identification for a service server, a call parameter definition to be passed with a call to the identified service server; and a response parameter definition to be returned by the identified service server.

In some example embodiments, the services within the AIF 144, except for the orchestrator 220, are not aware of each other, e.g., they do not interact directly with each other. The orchestrator 220 manages all the interactions with the other servers. Having the central coordinating resource simplifies the implementation of the other services, which need not be aware of the interfaces (e.g., APIs) provided by the other services. Of course, there can be some cases where a direct interface may be supported between pairs of services.

FIG. 6 is a graphical representation of a service sequence for a chat search with input text, according to some example embodiments. Previous solutions utilize hard-coded routers (e.g., including program instructions for each specific service) for managing the interactions between the different services. But hard-coded routers are inflexible for adding new activities, and are costly to modify, because hard-coded routers require reprogramming large programs in order to implement new services further. After each change, the new program has to be tested for all its features. Also, as the number of features includes, the complexity of the program grows, making it more probable to include bugs and harder to modify.

However, using a flexible system with a configurable orchestrator, allows for the simplified addition of new activities by inputting new sequences to the orchestrator. Each activity can be broken down to into a series of interactions that happen between the service servers, referred to as a sequence, and the sequence can be defined using a high-level definition that can be inputted into the orchestrator. After the orchestrator processes the new sequence (e.g., parsers and configures), and the corresponding services are prepared (if necessary), the AIF 144 is ready to provide the new feature to the user associated with the configured activity.

FIG. 6 provides an example embodiment for a graphical representation of how the sequence is defined. At the top, services BFF 504, orchestrator 220, identity 522, etc. are represented. Vertical lines below each service identify when an interaction takes place by that service.

FIG. 6 presents a sequence for a chat with the user that is typing text. For example, the user types, “I want to buy leather messenger bags.” The user wants to know information about the available leather messenger bags and what leather messenger bags are available in inventory, the desired output.

The BFF 504 receives the input text and sends the input text to the orchestrator 220. The orchestrator 220 sends the user identifier of the user making the request to the identity 522 service, to gather information about the user. This information may be relevant to the item being searched, such as is the messenger bag is for a man or for a woman. By gathering this information, it is not necessary to ask the user. The identity 522 service then returns user information, also referred to as identity, to the orchestrator 220.

The orchestrator 220 combines the identity with the input text message and sends the combination to the NLU 206, which is generally in charge of interpreting the request. The NLU 206 identifies the intent of the user (e.g., what is the purpose of the user request), as well as related entities and aspects related to the request, and returns them to the orchestrator 220.

Aspects relate to items associated with the request that further narrow the field of possible responses. For example, aspects may include type of material (e.g., leather, plastic, cloth), brand name, size, color, etc. Each aspect has a particular value, and questions may be asked to narrow down the search in reference to any of these aspects. In one example embodiment, a knowledge graph is utilized to identify the aspects, based on analysis of user behavior while interacting with the system. For example, when users looks for messenger bags, what is the click pattern of these users while searching for messenger bags (e.g., selecting brand, or color, or added results to the search query). The NLU 206 may provide questions to be asked with reference to the intent and the aspects. For example, the NLU may indicate asking, “I have messenger backs for these four brands A, B, C, and D; do you have a brand preference?”

The NLU utilizes machine learning to be able to understand more complex requests based on past user interactions. For example, if a user enters, “I am looking for a dress for a wedding in June in Italy,” the NLU 206 identifies that the dress is for warm weather and a formal occasion. Or if a user enters, “gifts for my nephew”, the NLU identifies a special intent of gifting and that the recipient is male, and that the aspects of age, occasion, and hobbies may be clarified via follow up questions.

The orchestrator 220 sends the intents, entities, and aspects to the dialogue manager 204, which generates a question for the user. After the user responds, the sequence may enter a loop that may be repeated multiple times, and the loop includes options for searching, asking additional questions, or providing a response.

When the action is a search, the orchestrator sends the search with the identified parameters and parameter values to the search 218 server, which searches the inventory. Search 218 returns search results to the orchestrator 220. In response, the orchestrator sends a request to the dialogue manager 204 to create a response in plain language for the user.

When the action in the loop refers to a new question, the orchestrator sends a request to the NLU 206 with all the parameters identified during the interaction, and the NLU 206 returns the new entities and aspects. For example, the user may be asked, “Do you want black, brown, or white?” The user may respond, “Black,” or “I don't care about color.” When a response is finally available, the orchestrator 220 sends the response to the BFF 504 for presentation to the user.

The AIF 144 may be configured dynamically to add new activities. Once the graph is defined with the corresponding parameters (e.g., intend, aspects), the graph is added to the orchestrator 220, and the other services are trained to perform the related features associated with the new activity, if necessary.

In one example embodiment, the sequence may be represented by a series of interactions, each interaction being defined by the name of the service invoked by the orchestrator, the input transferred parameters, and the expected return parameters. For example, each interaction may be represented as <service identifier, input parameters, return parameters>, and a sequence is represented as {interaction 1, interaction 2, interaction 3, . . . , interaction n}, or {<service 1, inputs 1, return 1>, <service 2, inputs 2, return 2>, . . . <service n, inputs n, return n>}.

It is also possible, to have some interactions being executed in parallel between the orchestrator and all services, which may be represented as interactions enclosed within brackets. Thus, if interactions 2 and interaction 3 may be executed in parallel, a sample sequence may be defined as {interaction 1, [interaction 2, interaction 3], interaction 4, . . . , interaction n}.

In another example embodiment, the sequence may be entered as a table, where each row corresponds to an interaction. Thus a sequence may be defined according to the following table:

TABLE 1

| No. | Service | Inputs | Return |
|---|---|---|---|
| 1 | Identity | user ID | identity |
| 2 | NLU | input text | intent, entities, aspects |
| 3 | DM | intent, entities, aspects | action, parameters |
| 4 | Search | parameters | results of search |
| . . . | | | |

A special entry may be added to represent loops, and instead of the service, a list of interactions for the loop would be provided. In addition, conditions may be included to determine when an interaction is executed or skipped.

In other example embodiments, activity definition may be defined utilizing standards protocols for data transmission, such as XHTML, JSON, JavaScript, etc.

It is noted that the embodiments illustrated in FIG. 6 are examples and do not describe every possible embodiment. Other embodiments may utilize different sequence representations, include additional of fewer interactions, use high level definition languages, etc. The embodiments illustrated in FIG. 6 should therefore not be interpreted to be exclusive or limiting, but rather illustrative.

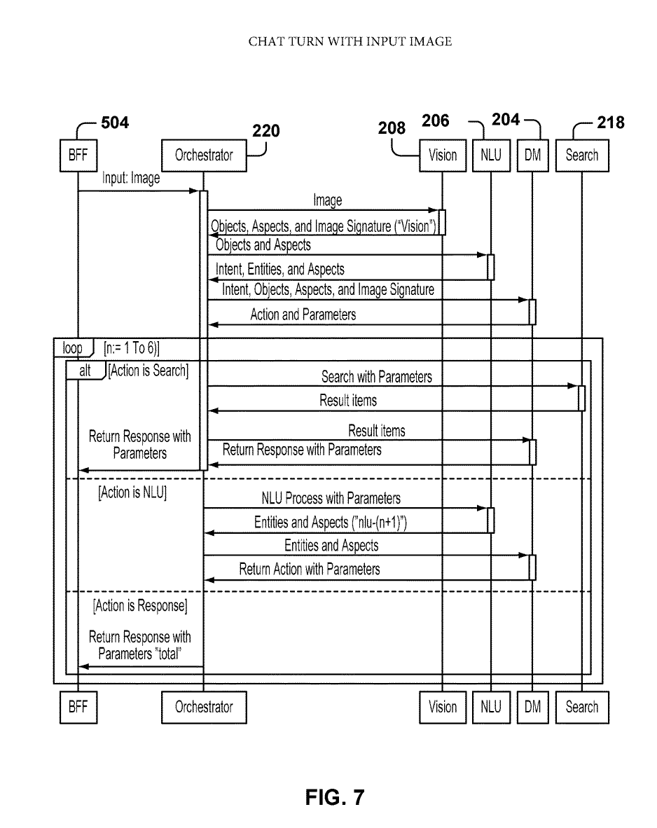

FIG. 7 is a graphical representation of a service sequence for a search with image input, according to some example embodiments. FIG. 7 illustrates a sequence similar to the sequence of FIG. 6, but instead of entering the text query, the user inputs an image indicating the item of interest.

Since the query is much more specific, the identity service is not invoked, although in other example embodiments the identity of the user can also be requested. After the orchestrator 220 receives the image from the BFF 504, the orchestrator 220 sends the image to the vision recognition server 208. The vision 208 analyzes the image to identify the object and relevant characteristics (e.g., color, brand), and sends back the object definition, aspects and an image signature, also referred to as “vision.”

The orchestrator 220 then continues the process as in FIG. 6 to search inventory and search the requested item. If necessary, one or more questions narrowing questions may be asked to the user, if necessary, to narrow the search. Once the results are obtained, the orchestrator 220 sends the results back to the BFF 504 for presentation to the user.

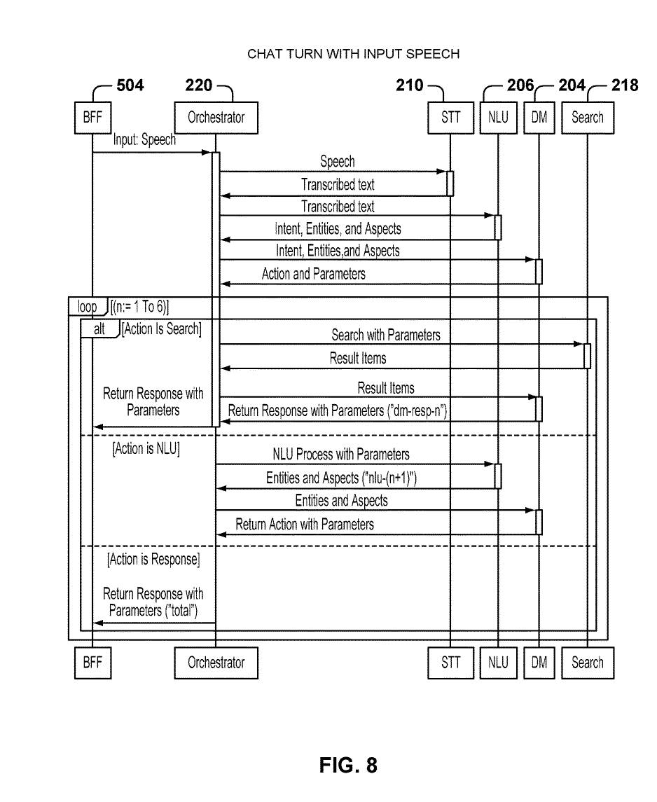

FIG. 8 is a graphical representation of a service sequence for a chat turn with speech input, according to some example embodiments. The sequence of FIG. 8 is also a chat with the user, but the input modality is for speech. Therefore, the speech-to text (STT) decoder 210 is invoked by the orchestrator 220 to analyze the input speech. The STT 210 analyzes the speech and converts the speech to text, which is returned to the orchestrator 220. From that point on, the process continues as in FIG. 6 to chat with the user in order to narrow the search.

It is noted, that in some example embodiments, the client has a text to speech converter. Therefore, if narrowing questions are sent to the client, the client may convert the questions into speech in order to implement a two-way conversation between the user and the commerce system.

In other example embodiments, the STT 210 may be invoked to convert questions for the user into speech, and the speech questions are then sent to the client for presentation to the user.

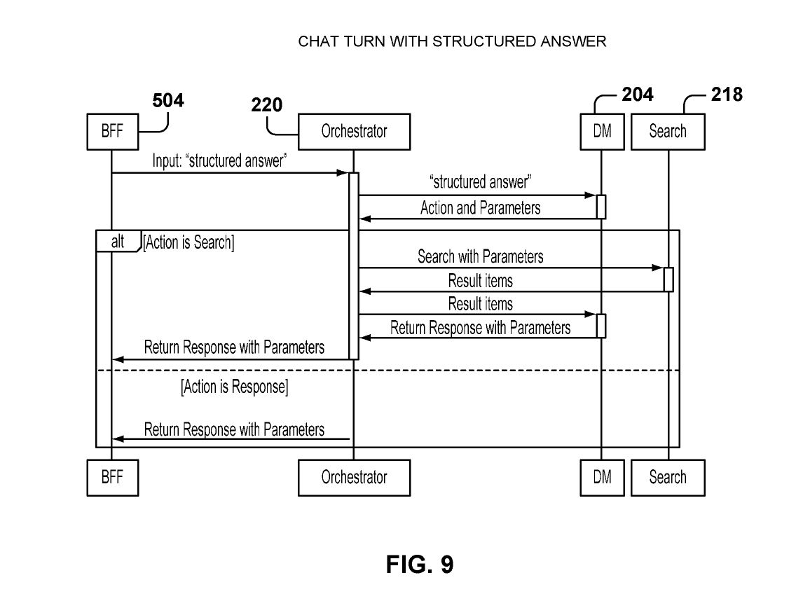

FIG. 9 is a graphical representation of a service sequence for a chat with a structured answer, according to some example embodiments. In some example embodiments, the client application performance functions of the NLU or provides choices to the user regarding filters for browsing. As a result, the client sends structure data ready for consumption by the DM 204.

Therefore, the BFF 504 sends the “structured answer” received from the client to the orchestrator 220, which then sends it to the DM 204. The DM 204 returns actions and parameters for the structured answer and the orchestrator sends the search request with the parameters to the search 218 server. If necessary, narrowing questions may be sent to the user for narrowing the search, by using the DM 204 to formulate the questions.

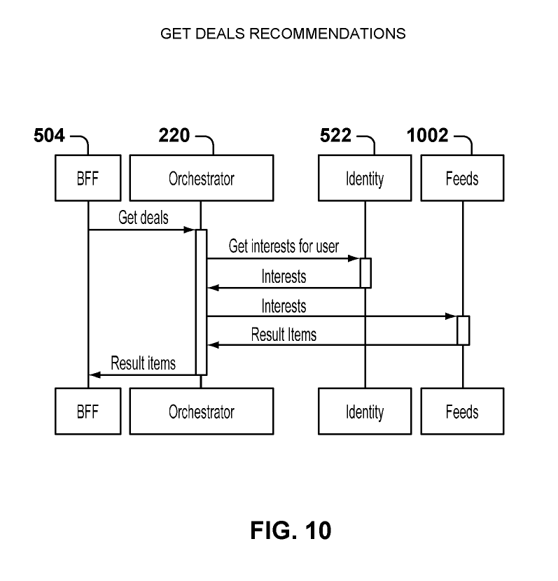

FIG. 10 is a graphical representation of a service sequence for a recommending deals, according to some example embodiments. In the example embodiment of FIG. 10, the user selects an option at the client device to get deals. In other example embodiments, the request to get deals may come in the form of a text, speech, or image, and the corresponding services would be invoked to analyze the query and determined that the user once a deal, which may be a deal on everything, or a deal on a particular area (e.g., shoes).

The orchestrator 220 receives the deals request from the BFF 504, and the orchestrator invokes the identity server 522 to narrow the deals search for items the user may be interested in. After the orchestrator 220 receives the interests from identity 522, the orchestrator 220 sends the interests to a feeds service 1002 that generates deals based on the interest of the user.

For example, the feeds server 1002 may analyze items for sale and compare the list price with the sales price, and if the sales price is below predetermined threshold percentage (e.g., 20%), then the corresponding item would be considered a good deal. Once the feeds server 1002 sends the result items to the orchestrator, the orchestrator 220 sends the result items to the BFF 504 for presentation to the user.

If a user has send a particular request for deals (e.g., “give me deals on shoes”) it will not be necessary to ask narrowing questions to the user, because the deals request is very specific. The identity service would retrieve whether the user is a male or a female, and the shoe size of the user (e.g., from past shopping experience), and the system will return deals for that user.

In other example embodiments, a chat may also be involved when searching for deals, and additional questions may be asked to the user. The dialog manager may be invoked to narrow the search for deals. For example, if the user asks, “show me deals,” the AIF 144 may present the user with a few deals and then ask to narrow the requests (such as clothing, electronics, furniture, travel).

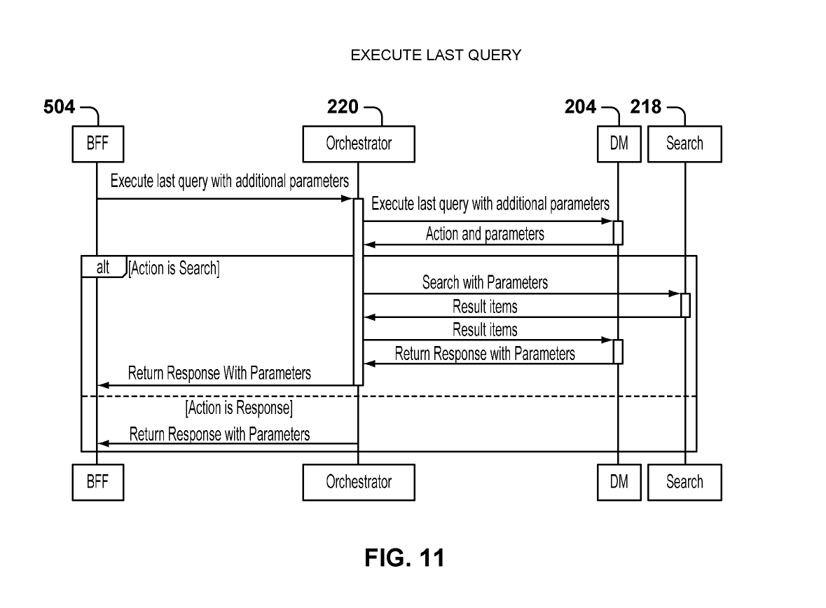

FIG. 11 is a graphical representation of a service sequence to execute the last query, according to some example embodiments. The sequence of FIG. 10 is for repeating a query that the user previously made, but with additional parameters received from the user.

The orchestrator 220 keeps a state and a history of ongoing transactions or recent transactions, so when the BFF 504 sends the request to execute the last query with additional parameters, the orchestrator 220 sends the information to the dialog manager for processing, and the DM 204 returns the action and parameters.

The orchestrator then sends the search with the parameters to the search server 218, which provides result items. The results of the search are sent back to the user, although if additional narrowing questions are desired, the narrowing questions are sent back to the user for clarification.

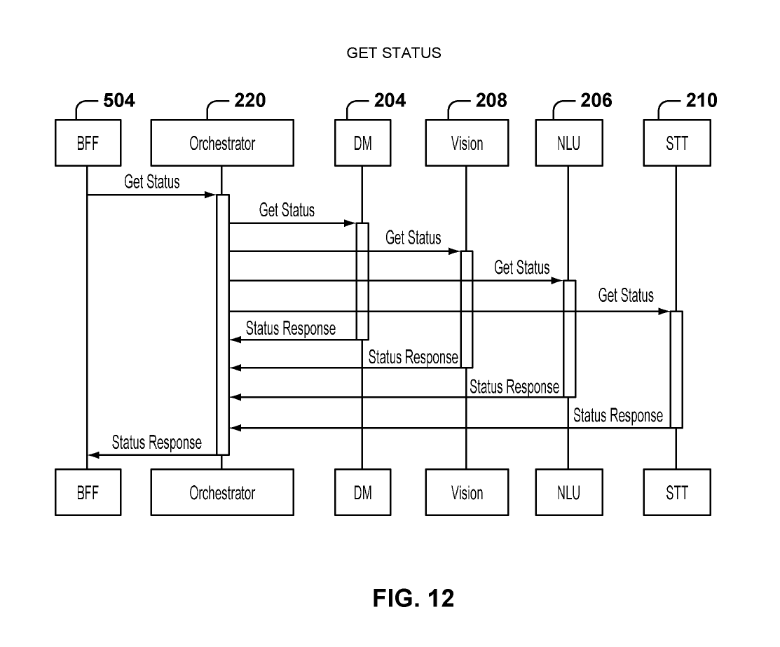

FIG. 12 is a graphical representation of a service sequence for getting status for the user, according to some example embodiments. The sequence of FIG. 12 is initiated when the user requests a status update. In one example embodiment, the orchestrator 220 sends the status requests in parallel to the DM 204, vision 208, NLU 206, and STT 210.

Once the orchestrator 220 receives the status responses from the corresponding services, the orchestrator 220 sends the status response to the BFF 504 for presentation to the user. It is noted that the orchestrator 220 will not always involve all the services to get their status, if the orchestrator state shows background for identifying what kind of status the user is searching for.

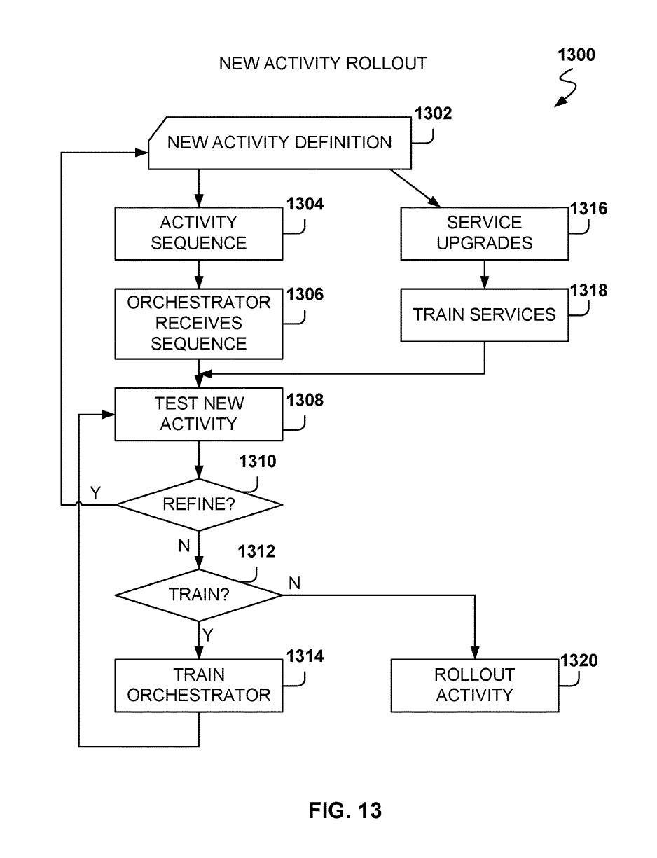

FIG. 13 is a flowchart of a method for configuring the orchestrator to implement a new activity, according to some example embodiments. While the various operations in this flowchart are presented and described sequentially, one of ordinary skill will appreciate that some or all of the operations may be executed in a different order, be combined or omitted, or be executed in parallel.

The goal is to have an orchestrator that can be dynamically configured, and where new patterns can be easily be input to the orchestrator via a sequence definition. Therefore, the orchestrator does not have to be re-coded, greatly improving the development time for adding new activities or new features, as well as reducing the cost.

For example, a new service is being added to the AIF 144 for requesting a shipping label for a package. The administrator develops a definition for the new activity 1302 which is captured within an activity sequence 1304. At operation 1306, the orchestrator receives the new sequence and parses the sequence to configure the orchestrator for the new activity. In addition, the new activity definition 1302 may involve service upgrades 1316 to one or more of the AIF 144 services beside the orchestrator.

If the user wants to ship an object for sale, in one example sequence, the orchestrator (via the dialog manager) asks the user to take a picture of the item to be shipped and the shipping address. Once that information is available, a shipping label is created for the user in order to ship the package. Several services may be involved for this new feature, such as the identity service to capture the address where the user is shipping from, the dialog manager to ask questions to the user, the vision service to analyze the image and identify its characteristics, such as weight and size, and a shipping service that creates a label based on the shipping-from address, the shipping-to address, the weight of the item, and the size of the item, etc. In one example embodiment, the orchestrator then sends a web link where the user can retrieve the shipping label.

In operation 1318, the required services to implement the new activity are trained. Not all the services involved may have to be retrained, only those with new features. For example, the shipping service may not need to be upgraded if the functionality exists already for creating a label based on the packet characteristics. Further, the vision service may not need to be upgraded if the vision service is already configured to detect the characteristics of the package. However, in some example embodiments, the vision service is upgraded in order to extract the characteristics for shipping if the vision service was not configured to identify these features.

The dialogue manager may also be upgraded to recognize the new intent and to generate dialogue with the user in order to ask the appropriate questions for shipping, such as the type of shipping (e.g., overnight, two-day shipping, etc.), or shipping address.

In some example embodiments, the upgraded activity involves training a machine-learning algorithm for one or more of the services. For example, in the case of the dialogue manager, training data is captured based on interaction between users and customer service, or data is created specifically to teach the dialogue manager. For example, the dialogue manager is presented with test data or curated data that shows what type of responses expected when a user enters a specific input. After the services are trained, the new activity is tested in operation 1308.

In some example embodiments, machine learning is also used to train the orchestrator to execute the operations in the sequence for the new activity. In some example embodiments, principles of artificial intelligence are used in order to simulate how the brain operates. If the stimulus is received here, the orchestrator is trained to generate an expected response.

After the new activity is tested, a check is made in operation 1310 to determine if the system is ready for rollout, or if more refinement is required (e.g., improve the sequence definition or the machine learning of the different services). If refinement is required, the method flows back to operation 1302, otherwise the method flows to operation 1312. In some example embodiments, A/B testing is used, where the new feature is rolled out to a limited set of users for testing.

In some example embodiments, the sequence is specific enough, that the orchestrator may not need to be trained to implement a machine learning algorithm, but in other example embodiments, the sequence may utilize machine-learning features within the orchestrator. If machine learning is needed by the orchestrator, the method flows back to operation 1314, and if training is not required, the method flows to operation 1320 where the new activity is ready for rollout and implementation.

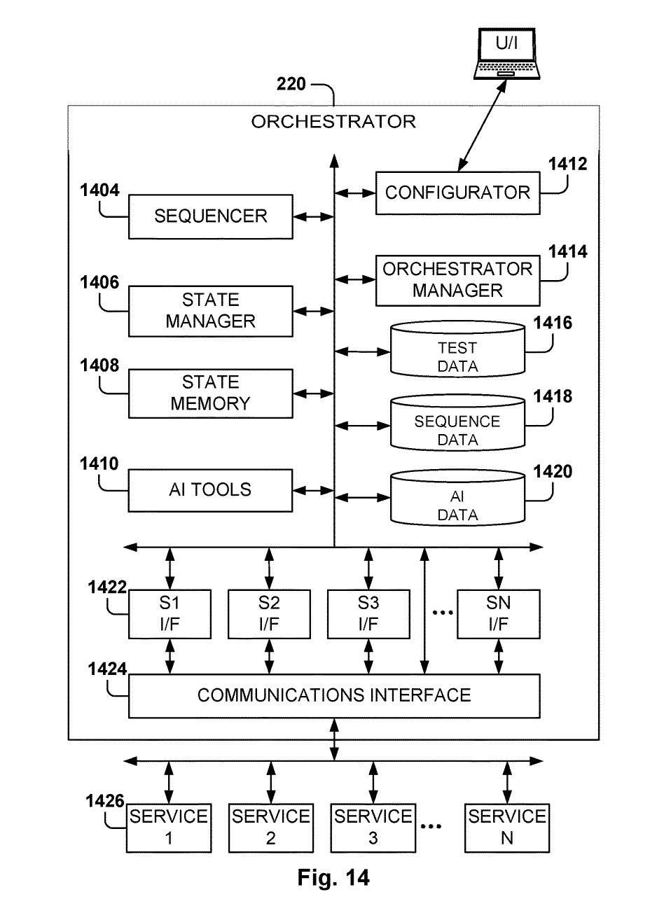

FIG. 14 is a block diagram illustrating an example embodiment of an architecture of the orchestrator. In one example embodiment, the orchestrator 220 includes a sequencer 1404, a state manager 1406, a state memory 1408, AI tools 1410, a configurator 1412, an orchestrator manager 1414, a plurality of service interfaces 1422, a communications interface 1424, and a plurality of databases. The databases include test data database 1416, sequence data database 1418, and AI data database 1420.

The orchestrator manager 1414 coordinates the activities within the modules in the orchestrator 220 and controls the ongoing operation of the orchestrator 220. The sequencer 1404 manages the implementation of sequences, and interact with the state manager 1406, which keeps track of the state of the ongoing sequences being executed. The state memory 1408 keeps the state of each activity, such as answers provided by the user or identity information previously obtained for the user. In addition, the sequence database 1418 gives a history of the activities performed by the orchestrator 220, and this historical data may be used by the AI tools 1410 to improve performance or add new features. The AI data used by the AI tools is stored in AI database 1420. The test data database 1416 keeps data used for testing of the orchestrator and the AIF 144.

The configurator 1412 provides data for a user interface which might be used by an administrator to add new sequence activities or modify existing sequent activities. The user interface may also provide data for the ongoing operation of the orchestrator 220 as well as statistical information.

The communications interface 1424 is used to connect the service interfaces 1422 to the corresponding service 1426. The communications may be implemented over any type of network or between processes operated in the same computing device.

It is noted that the embodiments illustrated in FIG. 14 are examples and do not describe every possible embodiment. Other embodiments may utilize different programs, combine the functionality of several programs into one program, include fewer or additional databases, etc. The embodiments illustrated in Figure should therefore not be interpreted to be exclusive or limiting, but rather illustrative.

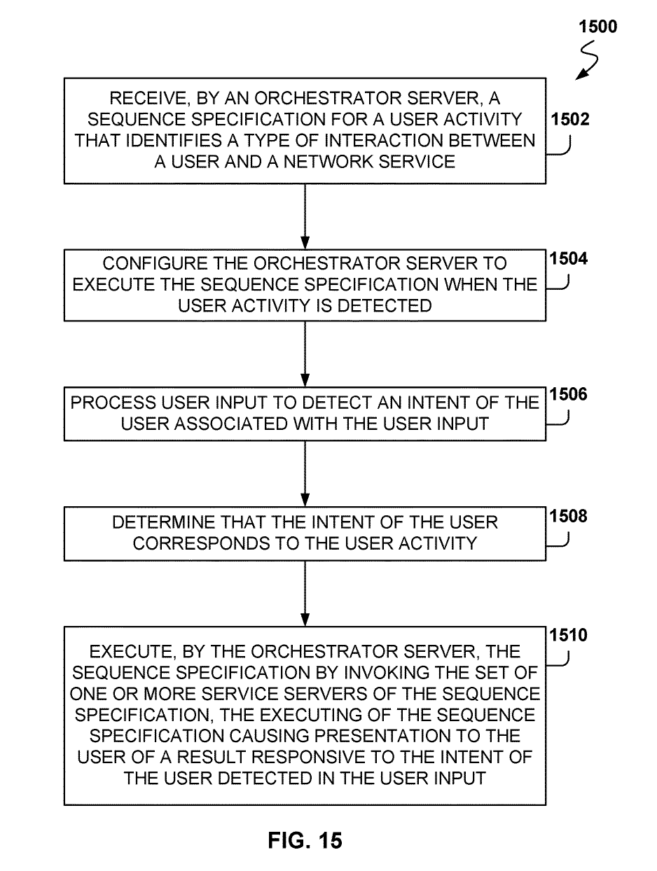

FIG. 15 is a flowchart of a method, according to some example embodiments, for adding new features to a network service. While the various operations in this flowchart are presented and described sequentially, one of ordinary skill will appreciate that some or all of the operations may be executed in a different order, be combined or omitted, or be executed in parallel.

At operation 1502, and orchestrator server receives a sequence specification for a user activity that identifies a type of interaction between a user and a network service. The network service includes the orchestrator server and one or more service servers, and the sequence specification comprises a sequence of interactions between the orchestrator server and a set of one or more service servers (from the one or more service servers) to implement the user activity.

From operation 1502, the method flows to operation 1504 where the orchestrator server is configured to execute the sequence specification when the user activity is detected. At operation 1506, the user input is processed to detect an intent of the user associated with the user input.

From operation 1506, the method flows to operation 1508 for determining that the intent of the user corresponds to the user activity. At operation 1510, the orchestrator server executes the sequence specification by invoking the set of one or more service servers of the sequence specification. The executing of the sequence specification causes presentation to the user of a result responsive to the intent of the user detected in the user input.

Implementations may include one or more of the following features. The method as recited where each interaction of the sequence of interactions includes identification for a service server, a call parameter definition to be passed with a call to the identified service server, and a response parameter definition to be returned by the identified service server. The method as recited where the sequence specification further includes a definition of a sequence intent, where the determining that the intent of the user corresponds to the user activity includes matching the sequence intent to the detected intent of the user.

The method as recited further including identifying data processing by a first service server associated with the sequence specification, collecting data related to the identified data processing, and include training a machine learning algorithm of the first service server to perform the identified data processing. The method as recited where the one or more service servers includes a natural language understanding server for interpreting language and for determining the intent of the user in the user input.

The method as recited where the one or more service servers includes a dialog manager server for establishing dialog with the user as required during the execution of the sequence specification. The method as recited where the user input is one of: text input, where the orchestrator server interacts with a natural language understanding server to process the text input; image input, where the orchestrator server interacts with a computer vision server to process the image input; or voice input, where the orchestrator server interacts with a speech recognition server to process the voice input.

The method as recited where the sequence specification is for a user search, where executing the sequence specification for the user search includes: interacting with an identity server to obtain user identification, interacting with a natural language understanding server to detect the intent of the user, interacting with a dialog manager server to identify search parameters, interacting with a search server to perform a search based on the identified search parameters, and interacting with a backend server to return results of the search to the user. The method as recited further including training a machine learning algorithm of the orchestrator server to process the sequence specification utilizing test data.

FIG. 17 is a block diagram illustrating components of a machine 1600, according to some example embodiments, able to read instructions from a machine-readable medium (e.g., a machine-readable storage medium) and perform any one or more of the methodologies discussed herein. Specifically, FIG. 17 shows a diagrammatic representation of the machine 1600 in the example form of a computer system, within which instructions 1610 (e.g., software, a program, an application, an applet, an app, or other executable code) for causing the machine 1600 to perform any one or more of the methodologies discussed herein may be executed. For example, the instructions 1610 may cause the machine 1600 to execute the flow diagrams of FIGS. 13 and 15. Additionally, or alternatively, the instructions 1610 may implement the servers associated with the services and components of FIGS. 1-12 and 14, and so forth. The instructions 1610 transform the general, non-programmed machine 1600 into a particular machine 1600 programmed to carry out the described and illustrated functions in the manner described.

In alternative embodiments, the machine 1600 operates as a standalone device or may be coupled (e.g., networked) to other machines. In a networked deployment, the machine 1600 may operate in the capacity of a server machine or a client machine in a server-client network environment, or as a peer machine in a peer-to-peer (or distributed) network environment. The machine 1600 may comprise, but not be limited to, a switch, a controller, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1610, sequentially or otherwise, that specify actions to be taken by the machine 1600. Further, while only a single machine 1600 is illustrated, the term “machine” shall also be taken to include a collection of machines 1600 that individually or jointly execute the instructions 1610 to perform any one or more of the methodologies discussed herein.

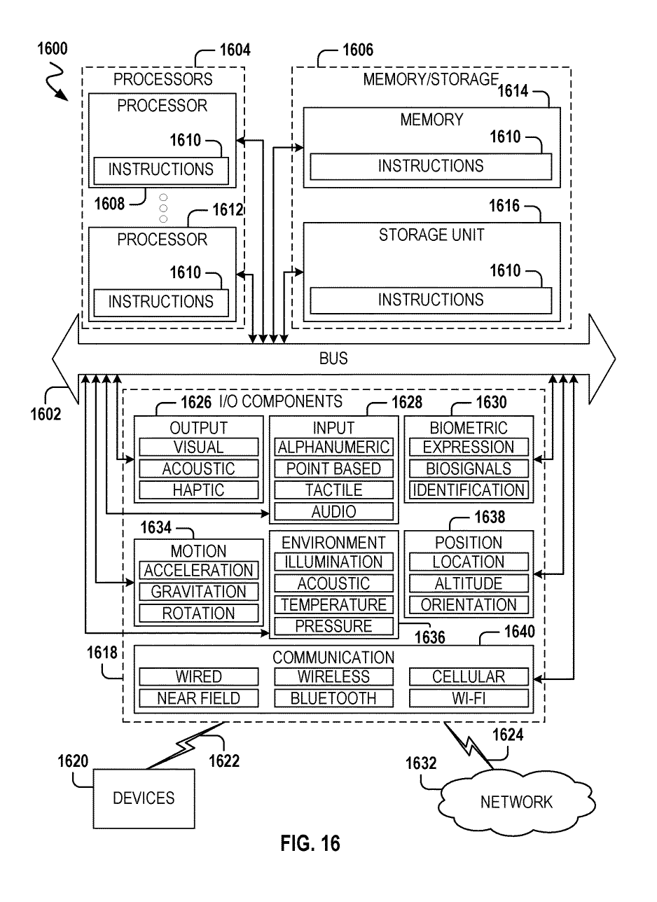

The machine 1600 may include processors 1604, memory/storage 1606, and I/O components 1618, which may be configured to communicate with each other such as via a bus 1602. In an example embodiment, the processors 1604 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1608 and a processor 1612 that may execute the instructions 1610. The term “processor” is intended to include multi-core processors that may comprise two or more independent processors (sometimes referred to as “cores”) that may execute instructions contemporaneously. Although FIG. 16 shows multiple processors 1604, the machine 1600 may include a single processor with a single core, a single processor with multiple cores (e.g., a multi-core processor), multiple processors with a single core, multiple processors with multiples cores, or any combination thereof.

The memory/storage 1606 may include a memory 1614, such as a main memory, or other memory storage, and a storage unit 1616, both accessible to the processors 1604 such as via the bus 1602. The storage unit 1616 and memory 1614 store the instructions 1610 embodying any one or more of the methodologies or functions described herein. The instructions 1610 may also reside, completely or partially, within the memory 1614, within the storage unit 1616, within at least one of the processors 1604 (e.g., within the processor's cache memory), or any suitable combination thereof, during execution thereof by the machine 1600. Accordingly, the memory 1614, the storage unit 1616, and the memory of the processors 1604 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 1610. The term “machine-readable medium” shall also be taken to include any medium, or combination of multiple media, that is capable of storing instructions (e.g., instructions 1610) for execution by a machine (e.g., machine 1600), such that the instructions, when executed by one or more processors of the machine (e.g., processors 1604), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1618 may include a wide variety of components to receive input, provide output, produce output, transmit information, exchange information, capture measurements, and so on. The specific I/O components 1618 that are included in a particular machine will depend on the type of machine. For example, portable machines such as mobile phones will likely include a touch input device or other such input mechanisms, while a headless server machine will likely not include such a touch input device. It will be appreciated that the I/O components 1618 may include many other components that are not shown in FIG. 16. The I/O components 1618 are grouped according to functionality merely for simplifying the following discussion, and the grouping is in no way limiting. In various example embodiments, the I/O components 1618 may include output components 1626 and input components 1628. The output components 1626 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1628 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 1618 may include biometric components 1630, motion components 1634, environmental components 1636, or position components 1638 among a wide array of other components. For example, the biometric components 1630 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1634 may include acceleration sensor components (e.g., accelerometer), gravitation sensor components, rotation sensor components (e.g., gyroscope), and so forth. The environmental components 1636 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1638 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1618 may include communication components 1640 operable to couple the machine 1600 to a network 1632 or devices 1620 via a coupling 1624 and a coupling 1622, respectively. For example, the communication components 1640 may include a network interface component or other suitable device to interface with the network 1632. In further examples, the communication components 1640 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1620 may be another machine or any of a wide variety of peripheral devices (e.g., a peripheral device coupled via a USB).

Moreover, the communication components 1640 may detect identifiers or include components operable to detect identifiers. For example, the communication components 1640 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1640, such as location via Internet Protocol (IP) geo-location, location via Wi-Fi® signal triangulation, location via detecting an NFC beacon signal that may indicate a particular location, and so forth.

In various example embodiments, one or more portions of the network 1632 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1632 or a portion of the network 1632 may include a wireless or cellular network and the coupling 1624 may be a Code Division Multiple Access (CDMA) connection, a Global System for Mobile communications (GSM) connection, or another type of cellular or wireless coupling. In this example, the coupling 1624 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1610 may be transmitted or received over the network 1632 using a transmission medium via a network interface device (e.g., a network interface component included in the communication components 1640) and utilizing any one of a number of well-known transfer protocols (e.g., hypertext transfer protocol (HTTP)). Similarly, the instructions 1610 may be transmitted or received using a transmission medium via the coupling 1622 (e.g., a peer-to-peer coupling) to the devices 1620. The term “transmission medium” shall be taken to include any intangible medium that is capable of storing, encoding, or carrying the instructions 1610 for execution by the machine 1600, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving, by an orchestrator server, a sequence specification for a user activity that identifies a type of interaction between a user and a network service, the network service including the orchestrator server and one or more service servers, the sequence specification comprising a sequence of interactions between the orchestrator server and a set of one or more service servers from the one or more service servers to implement the user activity;
configuring the orchestrator server to execute the sequence specification when the user activity is detected;
processing user input to detect an intent of the user associated with the user input;
determining that the intent of the user corresponds to the user activity; and
executing, by the orchestrator server, the sequence specification by invoking the set of one or more service servers of the sequence specification, the executing of the sequence specification causing presentation to the user of a result responsive to the intent of the user detected in the user input.

2. The method as recited in claim 1, wherein each interaction of the sequence of interactions comprises:
identification for a service server;
a call parameter definition to be passed with a call to the identified service server; and
a response parameter definition to be returned by the identified service server.

3. The method as recited in claim 1, wherein the sequence specification further comprises a definition of a sequence intent, wherein the determining that the intent of the user corresponds to the user activity comprises matching the sequence intent to the detected intent of the user.

4. The method as recited in claim 1, further comprising:
identifying data processing by a first service server associated with the sequence specification;
collecting data related to the identified data processing; and
training a machine learning algorithm of the first service server to perform the identified data processing.

5. The method as recited in claim 1, wherein the one or more service servers comprises a natural language understanding server for interpreting language and for determining the intent of the user in the user input.

6. The method as recited in claim 1, wherein the one or more service servers comprises a dialog manager server for establishing dialog with the user as required during the execution of the sequence specification.

7. The method as recited in claim 1, wherein the user input is one of:
text input, wherein the orchestrator server interacts with a natural language understanding server to process the text input;
image input, wherein the orchestrator server interacts with a computer vision server to process the image input; or
voice input, wherein the orchestrator server interacts with a speech recognition server to process the voice input.

8. The method as recited in claim 1, wherein the sequence specification is for a user search, wherein executing the sequence specification for the user search comprises:
interacting with an identity server to obtain user identification;
interacting with a natural language understanding server to detect the intent of the user;
interacting with a dialog manager server to identify search parameters;
interacting with a search server to perform a search based on the identified search parameters; and
interacting with a backend server to return results of the search to the user.

9. The method as recited in claim 1, further comprising:
training a machine learning algorithm of the orchestrator server to process the sequence specification utilizing test data.

10. An orchestrator server comprising:
a memory comprising instructions; and
one or more computer processors, wherein the instructions, when executed by the one or more computer processors, cause the one or more computer processors to perform operations comprising:
receiving a sequence specification for a user activity that identifies a type of interaction between a user and a network service, the network service including the orchestrator server and one or more service servers, the sequence specification comprising a sequence of interactions between the orchestrator server and a set of one or more service servers from the one or more service servers to implement the user activity;
configuring the orchestrator server to execute the sequence specification when the user activity is detected;
processing user input to detect an intent of the user associated with the user input;
determining that the intent of the user corresponds to the user activity; and
executing the sequence specification by invoking the set of one or more service servers of the sequence specification, the executing of the sequence specification causing presentation to the user of a result responsive to the intent of the user detected in the user input.

11. The orchestrator server as recited in claim 10, the instructions further comprising:
program instructions for a sequencer that manages execution of the sequence specification; and
program instructions for interfacing with the one or more service servers.

12. The orchestrator server as recited in claim 10, the instructions further comprising:
program instructions for a configurator that provides data for a user interface on a client device to enter the sequence specification; and
program instructions for an orchestrator manager that manages interactions with the one or more service servers.

13. The orchestrator server as recited in claim 10, wherein each interaction of the sequence of interactions comprises:
identification for a service server;
a call parameter definition to be passed with a call to the identified service server; and
a response parameter definition to be returned by the identified service server.

14. The orchestrator server as recited in claim 10, wherein the sequence specification further comprises a definition of a sequence intent, wherein the determining that the intent of the user corresponds to the user activity comprises matching the sequence intent to the detected intent of the user.

15. The orchestrator server as recited in claim 10, wherein the instructions further cause the one or more computer processors to perform operations comprising:
identifying data processing by a first service server associated with the sequence specification;
collecting data related to the identified data processing; and
training a machine learning algorithm of the first service server to perform the identified data processing.

16. A non-transitory machine-readable storage medium including instructions that, when executed by one or more processors of a machine, cause the machine to perform operations comprising:
receiving, by an orchestrator server, a sequence specification for a user activity that identifies a type of interaction between a user and a network service, the network service including the orchestrator server and one or more service servers, the sequence specification comprising a sequence of interactions between the orchestrator server and a set of one or more service servers from the one or more service servers to implement the user activity;
configuring the orchestrator server to execute the sequence specification when the user activity is detected;
processing user input to detect an intent of the user associated with the user input;
determining that the intent of the user corresponds to the user activity; and
executing, by the orchestrator server, the sequence specification by invoking the set of one or more service servers of the sequence specification, the executing of the sequence specification causing presentation to the user of a result responsive to the intent of the user detected in the user input.

17. The machine-readable storage medium as recited in claim 16, wherein each interaction of the sequence of interactions comprises:
identification for a service server;
a call parameter definition to be passed with a call to the identified service server; and
a response parameter definition to be returned by the identified service server.

18. The machine-readable storage medium as recited in claim 16, wherein the sequence specification further comprises a definition of a sequence intent, wherein the determining that the intent of the user corresponds to the user activity comprises matching the sequence intent to the detected intent of the user.

19. The machine-readable storage medium as recited in claim 16, wherein the user input is one of:
text input, wherein the orchestrator server interacts with a natural language understanding server to process the text input;
image input, wherein the orchestrator server interacts with a computer vision server to process the image input; or
voice input, wherein the orchestrator server interacts with a speech recognition server to process the voice input.

20. The machine-readable storage medium as recited in claim 16, wherein the sequence specification is for a user search of an image, wherein executing the sequence specification for the user search comprises:
interacting with a vision server to identify the image;
interacting with a natural language understanding server to detect the intent of the user based on the identified image;
interacting with a dialog manager server to identify search parameters based on the detected intent of the user;
interacting with a search server to perform a search based on the identified search parameters; and
interacting with a backend server to return results of the search to the user.
